(19) United States
(12) Patent Application Publication
(10) Pub. No.: US 2007/0088661 A1
(43) Pub. Date: Apr. 19, 2007

(54) Real-time deal engagement outcome determination

(75) Inventors: Peter De Verdier, Taby (SE); Fredrik Sjoblom, Alvsjo (SE)

Correspondence Address: NIXON & VANDERHYE, PC, 901 NORTH GLEBE ROAD, 11TH FLOOR, ARLINGTON, VA, 22203, US

(73) Assignee: OMX Technology AB, Stockholm (SE)

(21) Appl. No.: 11/250,611

(22) Filed: Oct. 17, 2005

(51) Int. Cl. H04K 1/00; G06Q 99/00; H04L 9/00

(52) U.S. Cl. 705/80; 705/1

(57) ABSTRACT

A real-time deal engagement outcome determination method and system as well as a deal engagement system implementing the method are disclosed. The real-time deal engagement outcome determination is based on the determination of the outcome of possible scenarios for received taken positions and setting a combined outcome as the deal engagement outcome. Any further taken positions having an outcome that effects any previously determined outcome will be added to the deal engagement outcome by the net effect and any further taken positions having an outcome not effecting previously determined outcomes will be added to the deal engagement outcome by a combined outcome of the further position taken. By utilising only worst case scenarios a risk determination can be made and by utilising only maximum case scenarios a gain determination can be made.

### TECHNICAL FIELD

The present invention relates to a method for real-time deal engagement outcome determination for users of a deal engagement system.

The present invention also relates to a real-time deal engagement system.

The present invention further also relates to a real-time deal engagement outcome method and system for deal engagement outcome determination.

### BACKGROUND ART

Deal engagement system is a term used in the present application that can be defined as encompassing any kind of system where a deal of some sort can or is to be engaged.

For instance, in the financial trade area, a deal engagement system could be a derivatives exchange where people buy and sell derivatives (such as options) or an exchange for any kind of financial instrument, energy or other security. CLICK™ from OMX Technology AB, Sweden is a typical example of a deal engagement system for trading financial instruments. Another example of such system is disclosed in U.S. Pat. No. 5,136,501.

Another example of a deal engagement system could be an auction system, where users offer goods, items, products, services, etc for sale and other users place bids on the offers according to the rules of the auction system.

Yet another example of a deal engagement system can be an event outcome system where users can take a position on the outcome of an event, e.g. who will win a certain (sports) game or a certain election, what the weather will be like on a certain day in the future, etc.

Essentially, any kind of determinable event (i.e. the outcome of the event can be established in an objective manner, e.g. by defining a specific event so that the outcome of the event is either true or false) could be subject to a taken position. With respect to terminology, this kind of event system (usually a betting system) often uses the terms lay and back (rather than offer and bid). One user thus can lay a condition (believing a specific outcome of an event will not occur, i.e. be false) and another user can back the condition (believing the specific outcome of the event will occur, i.e. be true). As will be evident below, a user may of course both lay and back the same specific outcome of the event, thus hedging his/her position. Such systems are known from, for instance, WO 01/77861 and WO 95/23383.

It may here be noted that although the terms “taken position” and “position taken” in certain financial trading have a specific limited meaning, they are in the present application used in their broadest sense. They are therefore intended to encompass the meaning that someone is willing to enter into a deal (selling, buying, laying, backing, offering, bidding, etc.) or has entered into a deal.

As a deal is normally between two sides, one side is seeking to enter into a deal and the other is accepting to enter into the deal or both are seeking to enter into a deal and the deal engagement system matches the two into a deal. Each side in this respect may of course comprise a plurality of users (whether affiliated or not). Users may or may not know the identity of other users involved in the deal.

It may also be noted that henceforth in the specification and claims the term “event” has a broader meaning than indicated above in relation to the background art. “Event” will essentially indicate the purpose of the taken position (or deal), regardless whether it's a financial trade, investments, auction, betting, etc. For instance, in a broad perspective, an investor enters into a financial trade hoping for a profit or avoiding a (greater) loss, e.g. purchasing a stock or option believing it will increase in value or selling a stock or option believing it will decrease in value (i.e. the “event” in such case is the increase or decrease in value).

From the above it follows that each event will have an outcome. More specifically, one of normally several possible outcomes will occur. For a party making a deal or taking a position, the possible outcomes represent what can be lost or gained. The possible outcomes can therefore be used as a basis for determining risk exposure and gain possibilities. Normally (in prior art systems) main focus is placed on risk analysis, but it should be made clear here that the present invention will not be limited to risk determinations.

Basically, in all kinds of deal engagement, there are thus risks involved. One obvious risk is that one or more of the parties of a deal cannot fulfil their commitments for the deal (insufficient amount of money, not having the object auctioned, etc.). Many providers of deal engagement systems (e.g. financial exchanges) therefore require that the users provide a pledged amount, collateral, funding or some other security so that engaged deals can be guaranteed to be fulfilled or completed in all aspects. It is of course possible to arrange for other guarantees for the fulfilment of an entered deal, with or without the involvement of the deal engagement system itself.

Another risk is of course that one of the parties of a deal can end up making a loss.

In a broader sense, risk could also be viewed as the risk of losing a profit on an investment (a stock that has increased in value after purchase may drop in value, resulting in less than optimal gain). In a situation where a large diversified investment strategy is used, it would be beneficial to be able to determine not only initial risk (invested capital) but also risks of losing a current profit.

Naturally, when there is a risk of losing, there is normally a chance of winning. Determining possible gain in real-time could provide a useful tool for users of deal engagement systems.

A balanced evaluation of risk and chance determined in real-time would also provide an excellent tool for many users.

Currently, there is no system available that allows an investor or similar to receive a full, real-time analysis of this kind of outcome determination, whether it relates to risk, chance (gain) or a balanced weighing of possible outcomes.

A certain type of users that would benefit from fast and accurate risk/gain/balanced engagement determinations are those whose purpose is to ascertain that there always are deals available (market makers in financial trades, bookmakers in betting, etc.).

It may be mentioned that also the providers of deal engagement system services may have a need to find any risks/gains, depending on how the service is formed. Thus, any risk/gain determination may have to involve a first step indicating who's risk is to be determined—a party on one side of the deal, a party on the other side of the deal, the provider of the deal engagement service or some other party effected by the risks involved. As an example of the latter part clearing houses and investment banks can be mentioned.

Certain risks/gains may be directly discernible at the time it is decided to take a position in relation to an event (investing, betting, etc.). When investing in stocks or other tangible assets, the value cannot become lower than zero. When betting or buying/writing certain types of options, there is a fixed determinable amount that can be lost or won. So, in many cases it is possible to decide beforehand a maximum risk (or maximum loss) that is acceptable for a certain deal as well as a maximum gain that is achievable.

In order to minimize risks (i.e. potential losses), some users make deals that at least in part cancel out each other. This is generally known as hedging. Hedging can be done at the time of entering a taken position (in the form of a combined taken position, that has to be agreed upon in its entirety) or at different times (for instance as an attempt to reduce the risks of a previously taken position). Hedging can also be used in a situation where a user wishes to safeguard a certain gain or profit, generally known as locking in a profit.

There are several problems that arise when attempting to determine risk exposures and/or gain possibilities in real time. One problem is to properly balance possible positive and negative outcomes of deals. For instance, only adding negative risk exposure for each deal entered provides a situation where unnecessarily high reserves may be locked or required from the users, which impedes on dealing itself.

Another problem is to actually provide a real time determination of the risk and/or gain. Calculating the possible exposure for every deal, and recalculating everything for each new deal entered, requires computing resources—especially when the financial business sector is regarded where a firm may have entered into several thousands of deal every day. Adding to this, the risk of unmatched taken positions can require further thousands of analyses.

One way of handling these kinds of determinations in the financial business (e.g. exchanges) is simply to wait until the exchange closes for the day and then calculate risk engagement for all deals.

Since many users engage in many different deals, it would be beneficial to provide a method and a system for determining the risk engagement and/or gain possibilities that the taken position(s) represent for the user or for another party.

More specifically, it would be of great value to achieve a risk/gain engagement determination that is performed in real-time. This would provide immediate information to the user of the current risk/gain engagement taken and, for instance, reduce the amount of collateral that may otherwise be necessary to be pledged by the users. In view of the fact that any computer (processor) based system has capacity limits, it would also be valuable if such real-time risk/gain engagement determination could be performed without placing too much load on the processing capacity.

### DISCLOSURE OF THE INVENTION

According to an embodiment of the invention there is provided a method for real-time deal engagement outcome determination where possible scenarios for a taken position are analysed in real-time and the deal engagement outcome is determined based on the scenarios. Upon a further taken position, it is first determined whether the further taken position has an effect on the analysed possible scenarios. If this is the case, only the net effect on the outcome is determined and the deal engagement outcome is modified by the net effect. If the further position taken has no effect on the analysed possible scenarios, further possible scenarios are analysed, a further deal engagement outcome is determined for the further possible scenarios and the real-time deal engagement outcome is modified by adding said further result. Both positive and negative outcomes are taken into account for all engaged deals (matched taken positions), whereas normally only negative outcomes are considered for non-engaged deals (unmatched taken positions), at least when considering risk analysis.

One advantageous selection of outcomes is performed in a risk exposure analysis where the minimum outcome (worst scenario) is selected for each position taken or each group of correlated positions taken.

Another advantageous selection of outcomes is performed in a gain possibility analysis where the maximum outcome (best scenario) is selected for each position taken or each group of correlated positions taken.

Yet another advantageous selection of outcomes is performed in a balanced analysis where all possible outcomes are assigned a weighing value and the total outcome is the sum of all outcomes times their respective weighing value.

The reason for only considering negative scenarios for non-engaged deals in risk determinations is that they represent taken positions that can be withdrawn. This can be more clearly explained as follows; basically, a proposal to enter into a deal has no real effect as long as no-one is willing to become a counterpart to that deal (i.e. engage into the deal, or match the taken position). As long as there is no match to the proposal, the proposal can normally be withdrawn. However, since a proposal that potentially may result in a deal has been put forth, the means for fulfilling such deal should also be provided. From a risk determining point of view it is thus necessary to determine even unmatched taken positions (proposals to a deal) for their possible negative outcome.

With the example of hedging, there are different situations that can occur.

An attempt to hedge a previously entered taken position (unmatched) by entering a proposal to a new deal (new taken position) that counters some or all of the negative outcome of the previous taken position has no positive impact on that previous taken position until the new deal proposal is matched. Likewise, the previous taken position has no positive impact on the new deal proposal until the previous taken position is matched. However, since both outcomes are not possible (in a hedging situation), only the worst of the two (previous taken position and new proposed deal) is considered as the risk engagement. When one or both of the previous taken position and new deal proposal finds a match, the risk engagement will normally be reduced, as there will be one positive and one negative outcome of the two hedging deals.

An attempt to hedge a previously entered deal (matched) will normally not change the risk engagement determination since there is no positive effect on the previously entered deal until a match is found for the new proposed deal, whereas the positive effect of the previously entered deal is present for the unmatched new proposed deal.

When a combined proposal to a deal is made, where the combination includes a plurality of parts (or legs) that hedge each other and where a match must be made for all parts (legs) simultaneously, it would be reasonable to make an exception from the above and also take account of the positive effects. This is due to the fact that the combination is an all-or-nothing proposal where it is not possible for a full negative outcome to occur (as the situation is for a corresponding number of separate taken positions).

The present invention is of great value for several kinds of purposes and users. It will allow providers of deal engagement services to present each user with their current true risk/gain engagement in real time. This results in more efficient handling of supplied and engaged deals for all parties. It reduces the amounts of collaterals necessary to proceed in further deals. The invention further provides users (especially users handling large amounts of deals or having large amounts of investments that pose a risk) with an excellent tool for supervising their own current situation. The invention further makes it possible to fulfil legal limits on risk engagement.

According to an embodiment of the invention, a deal engagement system is provided, comprising inputs for receiving information regarding a number of taken positions with respect to an event, where a position taken can include one or more of a quote, a request, an order, a bid and an offer, a matching engine for matching positions taken with respect to each event, an order book for storing unmatched events and a deal engagement outcome determination unit for determining a deal engagement outcome. Risk/gain/balanced engagement is determined by analysing the exposure of a user's taken positions by analysing possible scenarios. Once the scenarios for a taken position are established, a worst/best/balanced outcome can be determined and used as risk/gain/balanced engagement.

Such scenarios may have parameters that can be set by a user to determine possible outcomes that the user anticipates or wishes to investigate more thoroughly. This kind of use would be of greatest value when used in relation to risk engagement where the outcome of the deal is less certain and determinable at the time of making the deal. Of course, the present invention thus also provides a perfect tool for real-time simulation of how different actions (deals) could affect the user before proposing such deals (i.e. before entering a taken position).

In a broad sense, the method/system according to the invention manages the real time outcome analysis by vastly reducing the required calculations that traditionally have been necessary to a minimum of calculations by only regarding the net effect of each deal. Once the net effect is determined, the actual contents of the deal (price, amount, odds, etc.) become essentially irrelevant. The method/system only needs to keep sufficient information to update the overall risk engagement by a new deal. Basically, the scenarios that can occur (possible outcomes) can be viewed as nodes (a discrete number). It is not necessary to have each node representing an equally possible outcome, so each node may in fact represent different (statistical) likelihood or some other agreed-upon factor for each outcome. When utilising the outcomes for risk or gain determinations, a weighing of all outcomes can be made. The sum of all outcomes times the weighing factor for each outcome the represents the risk or gain. The weighing could be extreme, e.g. setting the factor for the worst outcome as 1 (100%) and all other outcomes as 0 in a risk determination or the best outcome as 1 (100%) and all other outcomes as 0 in a gain determination. Of course, a balanced determination could also be made. Such balancing could be made by any distribution of weighing factors (sum of which being 1, or 100%).

The analysis can for instance be made by structuring all the user's taken positions in a tree structure (preferably a structure displaying discrete components/nodes), which represents all possible outcomes of the taken positions. If a change occurs, e.g. the user takes another position relevant to the tree structure or a deal is made with respect to one of several taken positions (match is found), there is no need to recalculate the worst outcome—as would be necessary with existing systems. It is only necessary to determine what net impact the change has on the risk engagement analysis. Thus the risk engagement unit need not recalculate all possible scenarios every time a new taken position is entered or an unmatched taken position is matched. Only the net effect of the new position taken is necessary to determine. This will save a lot of calculation time and the few required calculations to update the risk engagement can easily be made in real time for all users providing fast and accurate information as well.

The above is also valid for gain or balanced analysis.

Apart from providing fast, real-time result of risk/gain/balanced engagement, the result can be used to achieve further beneficial advantages. One obvious advantage is that the system may automatically reserve resources (collateral) from users accounts (or similar) before a taken position is allowed to proceed to engage into a deal. In the alternative the system may require the user to provide collaterals before accepting a taken position into the system. As mentioned above, the information per se of the risk engagement taken provides a valuable tool for the user in planning ahead.

Another beneficial feature that can be used in combination with the method/system according to the invention is to add further criteria of dealing. Such criteria may be limits in risk engagement (thus preventing any new proposed deals from being entered if the total risk engagement thereby exceeds a limit—which may be defined by the user, the provider of the service, by law or any other relevant entity).

If the user is a company, e.g. a bank or broker firm, having many individuals making deals for the company, the present invention provides an excellent tool to determine the company's combined risk engagement in real-time thus enabling the individuals to alter their strategy in real-time (in known systems for financial trading, for instance, a user group can have a standing credit amount and balance is made each day after trading—which may be more costly than anticipated due to lack of overall view of the risk engagement).

### BRIEF DESCRIPTION OF THE DRAWINGS

The invention will be described in more detail with reference to the appended drawings in which:

FIG. 1 shows an embodiment of a deal engagement system according to the invention,

FIG. 2 shows an embodiment of an evaluation tree for determining risk engagement in a betting situation,

FIG. 3 shows an embodiment of an evaluation tree for determining risk engagement in a financial trading situation,

FIG. 4 shows a simplified basic structure explaining the analysis performed in the method according to the invention,

FIG. 5 shows an expanded structure of the structure in FIG. 4,

FIG. 6 shows a complex structure representing outcomes which have dependency on a multiple of parameters, and

FIG. 7 shows an embodiment of a stand-alone real-time risk engagement determination system.

### EMBODIMENTS

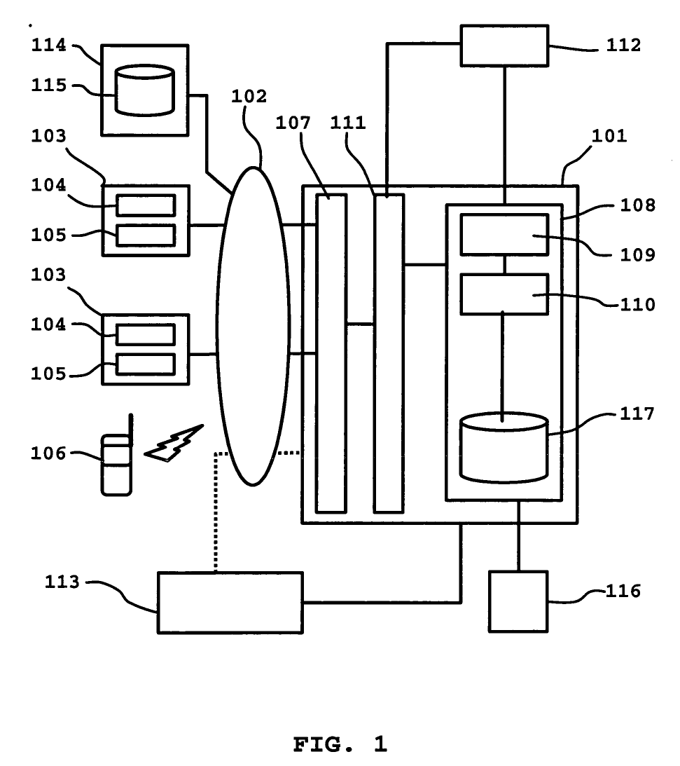

FIG. 1 shows an embodiment of a deal engagement system 101.

The deal engagement system 101 could essentially be a modified version of existing systems, such as CLICK™ from OMX Technology AB, Sweden, but other system architectures could also be utilized.

The purpose of the deal engagement system 101 is basically to match taken positions from users who wish to make a deal. Such deals can relate to trading financial instruments (stocks, futures, bonds, cash market, etc.), energy (gas, electricity, etc.), performing auctions, engage in betting, or any similar deal that requires a match between two or more parties.

Access to the deal engagement system 101 can be made in several ways, depending on what is suitable for the specific deals that are to be made. In the embodiment of FIG. 1, this is illustrated by a communication link 102. Communication link 102 may for instance be the Internet, a fibre based network, wireless network or any other means for communicating information (signals). The communication link 102 may of course utilise a combination of two or more different means for communicating information (signals).

The users who want to engage in a deal may communicate with the deal engagement system 101 via a terminal 103, comprising a screen 104 and an input means 105, a cell phone 106 or any other suitable means for generating information signals. The terminal 103 could for instance be a Personal Computer (PC) connected to the deal engagement system 101 via Internet (communication link 102).

Interaction with the deal engagement system 101 can also be made from automated sources, here illustrated by an automated market system 114, which comprises a computer 115 programmed to monitor the deal engagement system (prices, volumes, etc.) and act by sending in order (buy or sell) when certain programmed conditions are fulfilled. In essence, the automated market system 114 assumes the role of the user acting in accordance with the programming.

In a broad sense, when a user wishes to enter a deal, the user takes a position. Taking a position has slightly different meanings depending on what the deal relates to. If it relates to a financial instrument, such as a stock, future, bond or security, the taken position may indicate that the user is willing to buy or sell a specified volume of a security at a desired price. As explained previously, there are certain specific situations related to financial trading where “taken position” is used with a more specific and limited meaning. That is not the case here, where the more general meaning is intended. If it relates to betting, the taken position may indicate that the user is willing to back or lay a team in a game with a certain amount at a certain odds.

In short, a taken position indicates the user's requirements for engaging into a deal with a counterpart (or parties). These requirements need not even be fixed, but may actually be ranged or variables. For instance, a user may indicate an acceptable price range, volume range, odds range, etc. Such ranges or variables may facilitate for the user to reach a matched deal.

The deal engagement system 101 comprises several units. Since it is possible to construct these in several different ways, using hardware and software in different combinations, broad functional terms will be used for the parts that are not essential for the invention.

A pre-deal application unit 107 is set up to receive the communication from the communication link 102. Apart from constituting an input for the deal engagement system 101, the pre-deal application unit 107 is customised according to the type of deals that are to be engaged. For instance, if Internet is used as communication link 102, then the pre-deal application unit 107 may comprise a web application server.

Information is transferred from the pre-deal application unit 107 to a deal application unit 108 via a deal engagement outcome determination unit 111. For sake of simplifying the explanation of the embodiment, the deal application unit 108 is in this embodiment divided into a matching unit 109, an order book 110 and a memory 117 for engaged deals.

The matching unit 109 essentially compares incoming taken positions from the users and matches them into deals (when possible) according to rules and requirements given for the specific kind or type of deals that the deal engagement system 101 handles. The matched (engaged) deals are stored in memory 117. Any taken position not having a match can be transferred to the order book 110 for comparison with future taken positions from other users.

It is of course possible to implement different constraints on the order book 110. For instance, there may be temporal limits relating to how long a taken position can remain in the order book 110 un-matched, there may be user limits relating to different user types, where only privileged users will have their un-matched taken positions moved to the order book 110, etc.

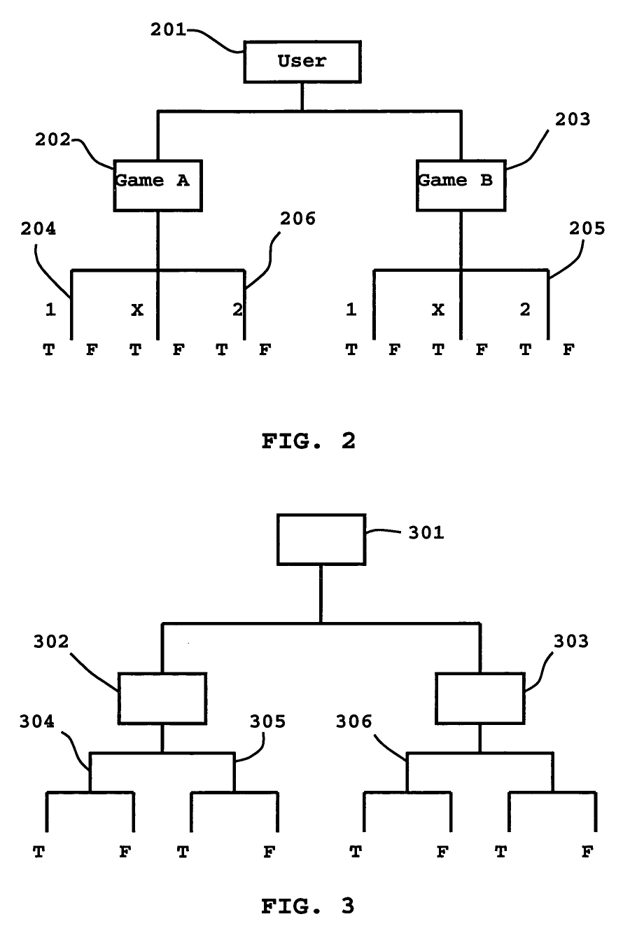

In the deal engagement outcome unit 111 the essential functions according to the invention are performed. These will be explained in more detail through the embodiments of inter alia FIG. 2 and FIG. 3 below. It should here be mentioned that as in any software-hardware related configuration, the deal engagement outcome unit 111 may include some or all of the hardware necessary to perform its functions or represent a software realisation/application using hardware already present in the deal engagement system 101 (mainly hardware present in the deal application unit 108).

A post-deal application unit 112 is arranged after the deal application unit 108. The post-deal application unit 112 may for instance comprise clearance of deals, cash transfer, commodity transfer, etc. For completion of certain risk engagement determinations, it may be necessary to provide information from the post-deal application unit 112 to the deal engagement outcome unit 111.

The embodiment in FIG. 1 also indicates that certain privileged users (for instance market makers), supervisory installations or other special applications may have direct access to the deal engagement system 101 via a special application unit 113 (either directly or via the communication link 102—indicated with dashed lines).

Also in FIG. 1 another external system 116 is indicated. This could be another deal engagement system—similar to the deal engagement system 101. By interconnecting several deal engagement systems 101, 116 and allowing them to check each other for possible matching of deals the overall efficiency increases and also allows calculation of a user's overall risk engagement.

Before going into detail with specific embodiments, the analysis and overall basics of the method according to the invention will be described.

FIG. 4 displays a very simple structure 401 representing a situation where two possible outcomes are viewed, namely A and B. For simplicity, the scenario of flipping a coin can be regarded. Flipping a coin has the outcome of being either heads (outcome A) or tails (outcome B). From a statistical point of view, each flip will have a 50% likelihood of heads (A) and a 50% likelihood of tails (B). From a deal making point of view there are essentially four different deal positions that can be taken, namely backing “heads”, backing “tails”, laying “heads” and laying “tails” (in this case with only two outcomes, backing “heads” is of course equivalent to laying “tails” and backing “tails” is equivalent to laying “heads”). To determine a risk taken in relation to any of these deals a function F(x) is utilised to determine the outcome of such deal in each of the two possible outcomes. The outcome that represents the worst outcome is then used as risk engagement for that deal and the outcome representing the best outcome is used as gain engagement for that deal.

For instance, a normal bet regarding whether a flip of a coin results in “heads” would have the odds 2 (i.e. double the money since it is a 50% chance of winning—statistically the better would end up with neither loss nor gain if constantly backing “heads”). Anyone trying to lay “heads” for higher odds, for instance 3, will lose money in the long run. The nomenclature that will be used in the present application for bets is (with the example of backing “heads” with 100 at the odds of 2); back “heads” for 100@2 or back “heads” 100@2.

It may here be necessary to explain that there exists a plethora of different nomenclatures for representing odds. All of them can be used in the present invention, but for simplicity, only a few will be mentioned in relation to the embodiments.

Another necessary explanation relates to how the outcomes are determined in relation to how a system handles accounts.

View again the example of tossing a coin. The possible outcomes are “heads” and “tails”, so an analysis would involve determining the outcome of each. In order to determine a resulting outcome, other factors may however need to be established first.

Most important is how to handle accounts and movement of money. In the coin flip example a person is willing to bet 100. Naturally, it is expected that the person can fulfil his/her part of the bet, i.e. pay 100 to the counterparty in case he/she loses. But the money could be taken from the person before or after the event (coin toss) resulting in two different ways of rendering the outcomes.

If the money are taken from the person beforehand (as a guarantee that fulfilment of the bet can be made) the bet of backing “heads” for 100@2 result in the calculation, f(heads)=100*2=200, whereas the outcome f(tails)=0. This because in case of win, the person should have the money back (100) plus the profit (100), whereas in case of a loss, the person has already paid and need pay no more.

The other alternative is that the person gives some guarantee that the money can be paid (showing the money, locking the money in an account with no possibility for the person to withdraw them or any other reasonably safe manner accepted by both parties).

In that case, the calculations become different, namely f(“heads”)=100*(2-1)=100 and f(“tails”)=−100. This means that in case the person wins, he/she will receive 100 (the profit) and if he/she loses 100 will be taken from him/her. In the following examples and embodiments of the present invention, this latter nomenclature will be used unless otherwise stated.

If a new deal is made by the same user, it is in accordance with the invention only necessary to evaluate the net effect on the outcome (this will explained in more detail below in connection with FIGS. 2 and 3).

It is not necessarily so that each outcome is equally likely. This can be immediately understood by regarding the situation of flipping two coins (or flipping one coin twice) and only take interest in the situation of heads-heads as outcome A and all other outcomes (heads-tails; tails-head; tails-tails) as outcome B. Statistically, outcome A only has a 25% likelihood whereas outcome B has a 75% likelihood.

As with the former example, in a betting situation the odds would normally be 4 for outcome A (a statistical 25% likelihood), but of course, in a free betting situation a person may provide other odds.

Situations where different outcomes having differing likelihoods or in some other way need to be differentiated can be handled by attributing outcome A and outcome B with different value parameters for the risk engagement determination. It is a matter of choice if the user wishes to determine maximum risk/gain (where min/max value of the outcomes is used) or a balanced outcome.

FIG. 5 shows an enlarged structure 501 in comparison to the simple structure 401 in FIG. 4. The enlarged structure 501 have 9 outcomes, namely A, B, C, D, E, F, G, H and I. There is no limit as to the number of outcomes, but for practical reasons only a few are shown. A function F can then determine the result for each outcome, based on which the risk exposure and/or gain possibility is determined. The function itself can be fairly simple (as in the example with bets on coin tosses) or more complex. It is in fact a benefit with the method according to the present invention that due to the large reductions in overall computing, more complex determinations can be used.

In this instance it shall also be demonstrated that the outcomes can be applied to non-discreet situations. For instance, let's regard a stock. Buying a stock also implies taking a risk, namely that the stock will lose in value. The different outcomes A-I may here represent actual value-intervals of the stock. In the alternative, outcome E may represent a nominal value (purchase value) and outcomes A-D decreases in percentage of the nominal value and outcomes F-I increases in percentage of the nominal value.

It may here be noted that each outcome may also represent different analogue ranges. There is thus no need for equidistant digitisation of analogue outcomes.

In similarity with the above example, each outcome can be attributed with a specific value parameter.

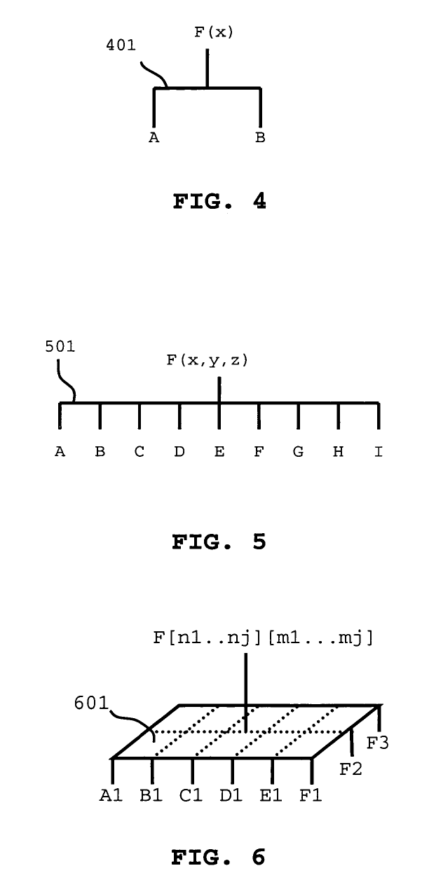

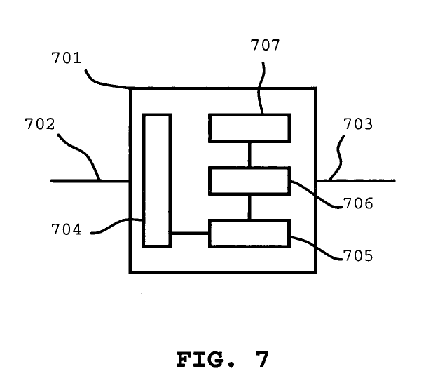

An even more complex structure 601 is shown in FIG. 6. Here the outcomes are represented in a plane (two-dimensional). There is of course no limit to the number of additional dimensions used from a mathematical point of view. Similarly a function F is indicated for calculating the result of each possible outcome. In this case there can be two different parameters that influence the result for each outcome. Essentially, the number of dimensions of possible outcomes can correspond to the number of different parameters that influence the result.

The structure of FIG. 6 may also be used for interrelating different events. For instance, A1-F1 may represent the outcomes of a first event and A2-F2 and A3-F3 may represent the possible outcomes for the first event in case other events (2 and 3) also fall out in certain ways.

The planar example of FIG. 6 can also be used to indicate another possibility that can be used with the present invention. Assuming that each column represents one possible scenario, each row may represent different functions used to calculate each outcome in that row (different evaluation criteria may be used in different functions leading to somewhat different results for the different scenarios).

Similar with the above two examples, different attributes may be applied for different outcomes and each outcome may represent a discreet delimitation of analogue values.

Referring now to FIG. 2, an embodiment of risk engagement calculation will be described in relation to a betting situation.

In this embodiment a user 201 is interested in taking positions on two games, game A 202 and game B 203. In this specific example, game A 202 and game B 203 (soccer, ice-hockey or some other sports game) are considered as events, where the outcome can be 1 (home-team wins), X (draw) and 2 (guest-team wins). For each game, one of these outcomes is true (T) and the others are false (F).

Assume that the user 201 only has 250 (£, $, or whatever currency that is accepted by the system) on the account and can thus only risk this amount of money.

Assume further that the user 201 for game A 202 wants to back the home-team with 100@1, 50, i.e. the user 201 loses 100 if the home-team loses or plays a draw, but wins 50 if the home-team wins. The user enters this into the deal engagement system. A corresponding counter-position exists in the deal engagement system and a match is made (locking a deal). The user's 201 account still contains 250, but 100 of these are reserved and locked (preventing the user 201 from using them in another deal.

The deal that the user has engaged in can be described as

TABLE 1

| Game A | | | Game B |
|---|---|---|---|
| 1 | Back | 100@1.50 | 1 |
| X | | | X |
| 2 | | | 2 |

meaning that user 201 has placed a bet backing the home-team to win game A. Such a table could be used as an information overview interface displayed to the user 201.

In determining the risk engagement taken by the user 201 with this bet, the possible outcomes for the possible results should be determined and analysed. This may be done by viewing results as true or false and calculate the outcomes, which provides the following list:
1 True X False 2 False user 201 wins 100*(1,50-1)=+50
1 False X True 2 False user 201 loses 100=−100
1 False X False 2 True user 201 loses 100=−100
   which can be abbreviated as
   Game A
1 T +50
X T −100
2 T −100.

In state of the art systems this calculation or calculations is/are made every time the users risk engagement is updated, which means that all details of the bet must be accessible for the risk determination unit at all times as well as requiring an unnecessary amount of calculations.

In the present invention, only the outcomes of the different results are stored, i.e.

Game A

memory
1 T +50
X T −100
2 T −100
The worst outcome is −100, which is the sum the user 201 must have available to be able to place the bet at all and which may be reserved automatically by the system when the user 201 enters the bet (as mentioned above).

Similarly, the user 201 is backing the guest-team in game B 203 with 100@3, 00. This gives the following table:

TABLE 2

| Game A | | | Game B | | |
|---|---|---|---|---|---|
| 1 | Back | 100@1.50 | 1 | | |
| X | | | X | | |
| 2 | | | 2 | Back | 100@3.00 |

Similar to what was stated above, a state of the art system would now calculate all outcomes for Game A (again) and also the outcomes for Game B. The result of those calculations is the following:

| | |
|---|---|
| Game A | Game B |

| | | | |
|---|---|---|---|
| 1 T | +50 | 1 T | −100 |
| X T | −100 | X T | −100 |
| 2 T | −100 | 2 T | +200 |

With the present invention, the outcome of Game A is already stored in a memory and will not be affected by the outcome of Game B, so it is only necessary to calculate the outcomes for Game B, store them as well and determine the risk (sum of worst outcomes), leading to the following:

| | |
|---|---|
| Game A | Game B |

| | memory | | memory |
|---|---|---|---|
| 1 T | +50 | 1 T | −100 |
| X T | −100 | X T | −100 |
| 2 T | −100 | 2 T | +200 |

Risk = sum of worst outcomes = −100 + −100 = −200

So, already at this point the present invention provides a saving on the load of the processor in that fewer calculations are necessary.

As these two games are completely unrelated (no correlation) the total risk engagement the user 201 has made at this point is the sum of the worst outcomes of game A and game B, i.e. −100+−100=−200. This leaves user 201 with an uncommitted 50 in the account to place further bets for.

As previously explained, one of the major advantages and principles of the present invention is that only the net result need to be stored. There is no need to store any individual specific information about any deal (in the present embodiment bets)—other then to determine correlation and matching effects. Correlation occurs in the present embodiment when a further bet is placed in any of the games A and B. Matching effects are important since, as explained above, only negative effects are considered for non-matched taken positions.

The required indicators are basically: which game has bets been placed in and what is the net outcome (the different scenarios for the placed bet). Notably, the details in the placed bet (bet result, sum, odds, etc.) are not present in the above rendering, since they are no longer necessary for the determination. For any additional bet(s) it is only necessary to determine if there is a correlation and what the net effect is.

Let's now view the situation where the user 201 wishes to put further bets in both of games A and B. The reason for doing so is not really relevant, but may be that the user 201 has obtained new information with respect to the games A and B (such as injuries of key players, weather conditions, early development of the games after they started or any other information that the user 201 believes may have an impact one or the other way).

As has already been established, the user 201 has 50 left on the account to spend on another deal (without risking any more than the original amount of 250).

Assuming that the user 201 wishes to increase the backing of the result 2 T in game B as much as possible (where the user 201 already have a deal of 100@3, 00). The user 201 finds an unmatched taken position of 100@2, 5. With the 50 left on the account, the user may only take half of this position, leading to the following table:

TABLE 3

| Game A | | | Game B | | |
|---|---|---|---|---|---|
| 1 | Back | 100@1.50 | 1 | | |
| X | | | X | | |
| 2 | | | 2 | Back | 100@3.00 |
| | | | | Back | 50@2.50 |

Again, to illustrate the benefits of the present invention, it is reminded that a state of the art system would re-calculate the outcomes of both Game A and Game B to determine the risk engagement. The following numbers should then result:

| Game A | | | Game B | | | |
|---|---|---|---|---|---|---|
| | 1 T | +50 | 1 T | −100 | −50 | = −150 |
| | X T | −100 | X T | −100 | −50 | = −150 |
| | 2 T | −100 | 2 T | +200 | +75 | = +275 |

The total risk has increased by 50 and the total risk (game A+game B) is now 250, i.e. the full amount on the account.

With the present invention, only the outcomes of the latest bet need to be determined and the stored results modified by the new bet results, i.e.

| Game A | | Game B | | | |
|---|---|---|---|---|---|
| | memory | | memory | modifier | new value |
| 1 T | +50 | 1 T | −100 | −50 | = −150 |
| X T | −100 | X T | −100 | −50 | = −150 |
| 2 T | −100 | 2 T | +200 | +75 | = +275 |

and after the modification, the stored information is

| | |
|---|---|
| Game A | Game B |

| | memory | | memory |
|---|---|---|---|
| 1 T | +50 | 1 T | −150 |
| X T | −100 | X T | −150 |
| 2 T | −100 | 2 T | +275 |

Risk = −100 + −150 = −250

Instead of calculating all outcomes for three bets, the method according to the invention only required the calculation of one bet to update the user's risk engagement.

Although it appears as if the user 201 has reached the limit and should not be able to put any further bets, the user 201 can make use of the specific features of the risk determinations made in accordance with the present invention and actually increase the number of deals (bets) without increasing the risked amount.

Thus, let's assume that there is an unmatched position of backing the home team in game A for 100@1, 20. The user 201 is willing to match that position and puts in a position of laying the home team in game A for 100@1, 20, which results in a match. The user's 201 current bets can then be viewed in the following table:

TABLE 4

| Game A | | | Game B | | |
|---|---|---|---|---|---|
| 1 | Back | 100@1.50 | 1 | | |
| | Lay | 100@1.20 | | | |
| X | | | X | | |
| 2 | | | 2 | Back | 100@3.00 |
| | | | | Back | 50@2.50 |

The calculations required in a state of the art system are now becoming more numerous and result in the following risk determination for the user 201:

| Game A | | | | Game B | | | |
|---|---|---|---|---|---|---|---|
| 1 T | +50 | −20 | = +0 | 1 T | −100 | −50 | = −150 |
| X T | −100 | +100 | = ±0 | X T | −100 | −50 | = −150 |
| 2 T | −100 | +100 | = ±0 | 2 T | +200 | +75 | = +275 |

Whereas only one further calculation is required with the present invention:

| Game A | | | | Game B | |
|---|---|---|---|---|---|
| | memory | modifier | new value | | memory |
| 1 T | +50 | −20 | = +30 | 1 T | −150 |
| X T | −100 | +100 | = ±0 | X T | −150 |
| 2 T | −100 | +100 | = ±0 | 2 T | +275 |

and after the modification, the stored information is

| | |
|---|---|
| Game A | Game B |

| | memory | | memory |
|---|---|---|---|
| 1 T | +30 | 1 T | −150 |
| X T | ±0 | X T | −150 |
| 2 T | ±0 | 2 T | +275 |

Risk = 0 + −150 = −150

So, although laying the home-team could theoretically result in a loss of 20 (20 more than currently on the account), this deal actually hedges the risk exposure in game A so that game A no longer can result in a loss. User A can however no longer gain as much as initially (+30 instead of +50) in game A.

More notable is the fact that the total risk is reduced to 150 through this hedging bet, thus freeing 100 for the user 201 to spend on more bets.

We can further assume that there is still an outstanding unmatched deal (taken position) for laying the guest team in game B (i.e. the remaining 50@2, 50). The user 201 wishes to take this deal and accepts it (by backing the guest team in game B for 50@2, 50). This leads to the following table:

TABLE 5

| Game A | | | Game B | | |
|---|---|---|---|---|---|
| 1 | Back | 100@1.50 | 1 | | |
| | Lay | 100@1.20 | | | |
| X | | | X | | |
| 2 | | | 2 | Back | 100@3.00 |
| | | | | Back | 50@2.50 |
| | | | | Back | 50@2.50 |

Again, the state of the art system starts to re-calculate all previous results and outcomes for the five bets in order to arrive at the following overall risk determination:

| Game A | | | | Game B | | | | |
|---|---|---|---|---|---|---|---|---|
| 1 T | +50 | −20 | = +30 | 1 T | −100 | −50 | −50 | = −200 |
| X T | −100 | +100 | = ±0 | X T | −100 | −50 | −50 | = −200 |
| 2 T | −100 | +50 | = ±0 | 2 T | +200 | +75 | +75 | = +350 |

And the determination required with the method according to the invention is to modify the stored net results with the latest bet, i.e.

| Game A | | Game B | | | |
|---|---|---|---|---|---|
| | memory | | memory | modifier | new value |
| 1 T | +30 | 1 T | −150 | −50 | = −200 |
| X T | ±0 | X T | −150 | −50 | = −200 |
| 2 T | ±0 | 2 T | +275 | +75 | = +350 |

and after the modification, the stored information is

| | |
|---|---|
| Game A | Game B |

| | memory | | memory |
|---|---|---|---|
| 1 T | +30 | 1 T | −200 |
| X T | ±0 | X T | −200 |
| 2 T | ±0 | 2 T | +350 |

Risk = 0 + −200 = −200

The benefits of the risk engagement determination according to the present invention are now becoming more obvious. Consider the situation where user 201 has thousands of bets. Entering another bet only requires one calculation with the present risk engagement determination method, whereas a state of the art system would require a full re-calculation of all thousands of previous bets to make the same determination. This represents an enormous reduction in load on a processor.

The user 201 has now risked a total of 200 and might actually spend another 50 on further bets (or even more if the user 201 continues to hedge made bets).

Notably in the above is that the user 201 has managed to ascertain a potential profit in game A without actually risking any money. Such situations may occur when odds are constantly changing.

If there was a secondary market available for trading bets, user 201 could possibly cash in a profit by selling all bets on game A.

In the above embodiment only matched deals have been dealt with. It has, however, been mentioned that unmatched deals are only considered with their negative impact. To clarify how this may work in practice, the above embodiment will be used again.

In order not to repeat any unnecessary parts, we will start at the situation existing at table 3 above, which for convenience is repeated as table 6 below:

TABLE 6

| Game A | | | Game B | | |
|---|---|---|---|---|---|
| 1 | Back | 100@1.50 | 1 | | |
| X | | | X | | |
| 2 | | | 2 | Back | 100@3.00 |
| | | | | Back | 50@2.50 |

Since the effect of reducing the number of calculations is sufficiently explained above, only the necessary net effect used in the present invention will be presented henceforth. The following risk engagement result is valid for table 6:

| Game A | | | Game B | |
|---|---|---|---|---|
| | | memory | | memory |
| | 1 T | +50 | 1 T | −150 |
| | X T | −100 | X T | −150 |
| | 2 T | −100 | 2 T | +275 |

Now, in the embodiment above, it was assumed that there was an existing unmatched position for backing the home team in game A for 100@1, 20. In order to exemplify the situation when there is no match, it will now be assumed that such a position does not exist. Instead, it is the user A that initiates a bet by laying the home team in game A for 100@1, 20.

This produces the following overview in table form:

TABLE 7

| Game A | | | Game B | | |
|---|---|---|---|---|---|
| 1 | Back | 100@1.50 | 1 | | |
| | Lay | 100@1.20 | | | |
| X | | | X | | |
| 2 | | | 2 | Back | 100@3.00 |
| | | | | Back | 50@2.50 |

The unmatched position for user 201 is here indicated in italic, but any other means of differentiating between matched and unmatched deals are feasible. The following overall risk engagement result is:

| Game A | | | | Game B | |
|---|---|---|---|---|---|
| | memory | modifier | new value | | memory |
| 1 T | +50 | −20 | = +30 | 1 T | −150 |
| X T | −100 | +100 | = −100 | X T | −150 |
| 2 T | −100 | +100 | = −100 | 2 T | +275 |

The positive outcomes for the unmatched bet are underlined and not taken into account for the calculation. The overall risk engagement remains on 250. This is of course the only reason that the user 201 is allow to place the bet at all.

If someone engages into the lay deal, the risk determination changes (thus also removing the underlining of the positive outcome of +100) into the following:

| Game A | | | | Game B | |
|---|---|---|---|---|---|
| | memory | modifier | new value | | memory |
| 1 T | +30 | 0 | = +30 | 1 T | −150 |
| X T | −100 | +100 | = ±0 | X T | −150 |
| 2 T | −100 | +100 | = ±0 | 2 T | +275 |

It should be noted that only the positive net effect is present here since the negative effect has already been accounted for. It is a matter of convenience if the system is made to store also the positive effects in a memory and use them as the matching occurs or whether the system is made to view the matching as a “new” event where only the positive effects are calculated and used in the risk engagement determination.

Storing the positive effect for use when there is a match has an advantage in that it reduces the numbers of calculations. It however requires that the unmatched net effect is linked to the specific taken position, although it is not necessary to store any detailed information about the taken position. In essence, it would be sufficient to allot a sequential number for all entered positions by a user and link these to the (positive) net effect results determined. Thus, when the x:th taken position is matched, the corresponding (positive) net effect is allowed to effect the total risk engagement determination.

If an unmatched taken position is withdrawn before being matched, the negative effect taken into account must of course be reduced. This can be done either by also storing the negative effect in a correlated manner or by redoing the calculation upon the withdrawal of the taken position.

The calculations done for the “first” entered taken position can even, in certain circumstances, be used for the party that matches the position (reversed outcome). It would however require that the system looks first for a possible match and only if there is no match, a calculation is performed. It would also require some sort of look-up table, the use of sequential numbers mentioned above or similar.

Returning to the embodiment, the total risk in game A is now 0 and the total risk in game B is 150, resulting in a total risk engagement of 150. This means that the system no longer needs to reserve 250 for the user 201, who therefore have another 100 to place in a further deal (bet).

It may here be noted that the user 201 may again reduce the risk by further hedging of the situation in game A as well as by hedging the position in game B. In theory, it may even be possible for the user 201 to cancel out all risks.

One major benefit of the method becomes evident from the above, namely the reduced calculation time. Each taken position need only be considered as it is entered. After that, the risk engagement system no longer needs to know what the specific bets were (as the risk determination following the tables above show, only the risk/gain need possibly to be available). It doesn't matter if there are two or two thousand deals made by a user, since an additional deal only requires adding to the net effect of the other deals. This means that all risk engagement calculations can be made in real time and keep all users continuously updated of their risk engagement without impeding on the overall matching operation.

If the deal engagement system is so devised that trading in matched deals is allowed, a user can try to sell a matched bet before a game is finished to cash in a profit (or reduce a loss) in beforehand. Such profit would normally be less than the profit the user could gain through the bet itself, but that would be a normal distribution of profit and risk between the buyer and seller of such bet.

In the above embodiment(s) a gain analysis could also be made simultaneously by adding best outcome of the stored outcomes for each game.

A balanced analysis could also be made, for instance by adding all possible outcomes after adjusting them with a weighing value. By using ⅓ (3 possible outcomes) of each outcome a balanced value is obtained. Such balanced values are of great value for, for instance, bookkeepers as this gives them an additional check on the overall situation in a game. If the balanced outcome for a specific game deviates too much from a determined level, then something may be wrong (faulty distribution of odds, risk that a game may be exposed to illegal activities such as bribing a team to lose, etc).

There are several instances where a net change is necessary (i.e. where an update is necessary). Above entering a taken position and matching into a deal has been mentioned as well as removing a taken position before a match is made. Other situations are settlement (a game is over and the deal/bet is settled), partial match on an entered taken position, improved position (match with better condition than the entered taken position implied), etc. All of these can be handled with the present invention in similar ways to update the net situation for the user. Thus, only one determination is necessary for each change that occurs in contrast to re-evaluating the entire situation for each change.

One possible way for the risk engagement unit to record a multi-bet situation have been shown above. Another version, using the above nomenclature (numbers exemplified below are not related to the above example, they are only used to exemplify how a record could look like) could result in:
User Y: game I: (1 T)=+50[+50]; (X T)=−100[+50]; (2 T)=−75
   game II: (1 T)=−25[+50];(X T)=−50;(2 T)=+25[+25]

Where numbers in square bracket [ ] represent possible positive outcomes of un-matched taken position(s). For (2 T) in game I in this example, the negative effect of the un-matched taken position has already been considered and will not change if the taken position is matched. Thus in this example, the user's risk engagement in game I is reduced by 25 if the outstanding taken position is matched (worst scenario then becoming (2 T) instead of (X T)). Of course, since an un-matched taken position may be withdrawn, it may be preferable to keep the worst outcome for this in brackets at (2 T) as well. Assuming the worst outcome for (2 T) was [−25], a removal of the taken position before being matched would also result in (X T) becoming the worst outcome. Similar reasoning is valid for game II.

Another way of storing and handling risk engagement information is to use a matrix constellation. Below is an example for a user Z who entered into deals in five games (each line in the matrices representing a game and each row indicating a possible outcome) and further enters into a new deal for one of these (again, numbers have been chosen to exemplify the arrangement and are not related to any previous example given):

$$User Z \text{:} ( \begin{matrix}150 & - 100 & - 100 \\ - 125 & 50 & 50 \\ - 50 & 300 & - 50 \\ 250 & - 25 & 150 \\ 60 & 60 & 125\end{matrix} ) + ( \begin{matrix}- 60 & 75 & 75 \\ 0 & 0 & 0 \\ 0 & 0 & 0 \\ 0 & 0 & 0 \\ 0 & 0 & 0\end{matrix} ) = ( \begin{matrix}90 & - 25 & - 25 \\ - 125 & 50 & 50 \\ - 50 & 300 & - 50 \\ 250 & - 25 & 150 \\ 60 & 60 & 125\end{matrix} )$$

Where the first matrix indicates made deals (pending a result) and is thus the same as the user's net situation. The second matrix indicates the net outcome for the new deal and the third matrix shows the situation after the new deal's net effect has been viewed (for risk evaluation minimum value of each row is summed and for gain evaluation maximum value of each row is summed). In case of an unmatched taken position in one game, the following matrix configuration could occur:

$$User Z \text{:} ( \begin{matrix}90 & - 25 & - 25 \\ - 125 & 50 & 50 \\ - 50 & 300 & - 50 \\ 250 & - 25 & 150 \\ 60 & 60 & 125\end{matrix} ) + ( \begin{matrix}0 & 0 & 0 \\ \underline{50} & - 50 & - 50 \\ 0 & 0 & 0 \\ 0 & 0 & 0 \\ 0 & 0 & 0\end{matrix} ) = ( \begin{matrix}90 & - 25 & - 25 \\ - 125 & 0 & 0 \\ - 50 & 300 & - 50 \\ 250 & - 25 & 150 \\ 60 & 60 & 125\end{matrix} )$$

The underlined positive result (+50) is not considered when determining the new complete matrix for user z.

If there is a match, the new situation may be dealt with in several ways, such as:

$$User Z \text{:} ( \begin{matrix}90 & - 25 & - 25 \\ - 125 & 0 & 0 \\ - 50 & 300 & - 50 \\ 250 & - 25 & 150 \\ 60 & 60 & 125\end{matrix} ) + ( \begin{matrix}0 & 0 & 0 \\ 50 & 0 & 0 \\ 0 & 0 & 0 \\ 0 & 0 & 0 \\ 0 & 0 & 0\end{matrix} ) = ( \begin{matrix}90 & - 25 & - 25 \\ - 75 & 0 & 0 \\ - 50 & 300 & - 50 \\ 250 & - 25 & 150 \\ 60 & 60 & 125\end{matrix} )$$

That is, adding the “missing” value only. Another way would be to first “remove” the unmatched result and then add the matched result:

$$User Z \text{:} ( \begin{matrix}90 & - 25 & - 25 \\ - 125 & 0 & 0 \\ - 50 & 300 & - 50 \\ 250 & - 25 & 150 \\ 60 & 60 & 125\end{matrix} ) - ( \begin{matrix}0 & 0 & 0 \\ 0 & 50 & 50 \\ 0 & 0 & 0 \\ 0 & 0 & 0 \\ 0 & 0 & 0\end{matrix} ) + ( \begin{matrix}0 & 0 & 0 \\ 50 & - 50 & - 50 \\ 0 & 0 & 0 \\ 0 & 0 & 0 \\ 0 & 0 & 0\end{matrix} ) = ( \begin{matrix}90 & - 25 & - 25 \\ - 75 & 0 & 0 \\ - 50 & 300 & - 50 \\ 250 & - 25 & 150 \\ 60 & 60 & 125\end{matrix} )$$

There are of course other ways available to store and handle (update) the risk engagement information (as well as any gain or balanced engagement information when applicable).

The same or similar arrangements as those shown above can be made for other kinds of betting, e.g. where there are fewer or more possible outcomes, such as whether a winning team scores more than a specified number of goals (points), horse or dog racing, or who will score the first goal and other possible events, such as outcome of an election, etc. The arrangements described above can of course be extrapolated to cover virtually any number of (engaged and proposed) deals from one and the same user.

In FIG. 3, an embodiment relating to risk engagement determination for financial systems is disclosed. In this embodiment (stock) options are used as an example.

Basically, whether one deals with a call option or a put option, there is a commodity as a basis for the option, in this case a stock.

As with the previous embodiment, the situation is viewed from a user perspective, hence there is a user 301. Such user may be a private individual, a broker firm, bank, company or any other entity that is willing to enter a deal in financial instruments (options in this case).

For this specific embodiment, where stock options are regarded there can be a call option 302 or a put option 303. A call option 302 is a contract where the holder of the call option 302 at a determined time in the future can buy a determined volume of the stock at a determined price from the writer (issuer) of the call option 302.

The value of the call option 302 and the risk engagement taken respectively by the holder and writer can be viewed through the different outcomes, namely stock price increasing and stock price decreasing. For the writer of the call option 302, a final stock price above the set price is of course negative since this would lead to a (forced) sale of the stock for a price below the market value. Of course, for the holder this means a corresponding profit.

As has been mentioned above, the system uses a function to calculate the risk engagement for different scenarios. Such function (or functions) may be any currently known function for performing such calculations or be specially developed or adapted for the specific deal. In the present embodiment options are used as an example and the Black-Scholes option value formula can be mentioned as one well known function that may be used.

In the opposite case, i.e. a final stock price below the price, the holder would most likely not like to exercise the option and takes a loss represented by the premium paid for the option (which premium becomes a profit for the writer of the call option 302).

Similarly, a put option 303 is a contract where the holder of the put option 303 at a determined time in the future can sell a determined volume of the stock at a determined price to the writer (issuer) of the call option 302. The holder of the put option will therefore gain a profit if the final stock price is below the determined price since this means a sell for a higher price than the market value.

In case of a stock price increase 306 above the agreed price, the holder would not exercise the put option 303 and lose the paid premium for the put option (profit for the writer of the put option 303).

In the embodiment of FIG. 3, the user 301 can thus for instance decide to write 304 a call option 302. This is an indication that the user 301 believes the stock will remain stable or possibly go down in price. Should this outcome be true T, the user 301 will gain a profit from the holder of the call option 302.

Of course, the user 301 may have misjudged the market interest for the stock and this could increase in price, leading to a loss corresponding to difference between the final market price and agreed price times the volume of stocks. In theory, the loss is limitless, but in practice the market value will not increase beyond a certain reasonable limit.

In similarity to the previous embodiment, hedging can be done to balance out risk engagement, so a user 301 may (when realising that the stock value was misjudged or as a general risk balancing manoeuvre) have several options in the same stock. To counter the risk taken by writing 304 the call option 302, the user 301 can buy 305 a call option 302 for the same stock. If the user could buy 305 a call option 302 having the same volume, price and time out for the same premium the written 304 call option 303 had, the risk would be fully hedged (although it is unlikely that suck call option 303 would be available to buy on the market in that situation).

Alternately, the user 301 could write 306 out put options 303 for the same stock in order to hedge the risk engagement. Since there is a limit profit for writing 306 a put option 303 (the premium paid by the holder), a determination of the risk engagement is necessary.

As opposed to call options 302, put options 303 have essentially fixed maximum outcomes for the writer and holder of the put option 303.

Major actors in the financial market may have several thousands of different deals, bids and offers at the same time and it would be valuable to have real time information of the current risk engagement.

With the risk engagement determination according to the invention this is possible to achieve.

In a case like this, there is a direct correlation between the stock price and the outcome of the option. It is further not necessary to keep all facts regarding the specific option in a memory, or recalculate the risk engagement every time the stock price changes. It suffices to keep the combined outcome in the memory.

Of course, there are certain specific differences between a betting on a game and holding/writing options. One is that the betting of the game has a fixed risk engagement once entered into a deal. The option can give a theoretical limitless profit/loss (for call options—a put option has a determinable best/worst outcome) and there is basically a linear gradient between gain and loss depending on the final outcome. For most cases, though, the worst case represents the risk engagement. In case of the writing 304 a call option 302, a reasonable maximum loss must be determined where there is no hedging done.

For the embodiment of FIG. 3, the risk engagement for the user 301 can be illustrated as Option [stock]=−500000, meaning that the risk engagement is 500000 (amount that user 301 can reasonably lose, e.g. for a 100% rise in market value for the stock—a percentage representing reasonable outcome can be set by common agreement on the market for each stock or instrument where necessary).

The hedging done by the user 301, may or may not completely cover the risk, but as an example, the purchase of the call option 302 reduces the risk greatly and results in Option [stock]=−50000, i.e. a reduction of the risk engagement by 450000. In a situation where the user has a limited credit for dealing in financial commodities, it is important for both the user 301 and for the financial system that the risk engagement can be viewed in real time (instead of doing an end of the day sum up, which is normal for many financial systems today).

As with the previous embodiment, the risk engagement unit need not store any details concerning the specific deals made, only the outcome. The hedging made for the option is typical. The risk engagement unit needed only store the risk engagement of 500000 for the call option. The precise volume and agreed stock price is secondary. When the hedging order came, there was thus no need to recalculate the entire situation for the user, only the outcome of the new order and its possible effect on previous deals, in this case, there could not be a simultaneous negative effect and therefore, the risk engagement value could be reduced.

For the financial situation given above, it may further be of greater interest to the investor to have a balanced engagement outcome determination rather then a worst case scenario outcome.

Whether the scenarios are stored in form a tree-structure (similar to the figures), as matrices, formulas, or in any other way, is not pertinent. The risk engagement is focused on the principle of only needing to know the outcome of a new deal and update the risk engagement based on that outcome.

In FIG. 7, an embodiment of a stand alone real-time risk determination system 701 is shown. Such stand alone system can basically be used by anyone who wishes to maintain a real-time risk analysis of their activities in deals and other risk taking activities. A stand alone system can also be connected to existing deal engagement systems and used in the same manner as the integrated risk engagement determination unit 111 in FIG. 1.

The stand alone real-time risk determination system 701 comprises an input 701 for receiving taken positions and an output 703 for outputting a current risk engagement. The input may also be used for entering any necessary information that has an influence on the risk engagement determination.

Further, there is a preparation unit 704, which in the present embodiment codifies the input taken position. Based on the codified information, a selection of a proper node-structure and associated function can be made in a structure unit 705. For advanced uses, the structure unit 705 may include thousands of different structures suitable for determination of risk engagement in all types of deals.

After a structure has been selected a calculation unit 706 determines the risk engagement for the taken position using the selected structure.

The result is then used to update a current risk engagement stored in a memory 707.

It may here be noted that the calculation unit 706 may be closely integrated with the memory 707 and first check whether the selected structure has been selected for a similar taken position before. In such case only the net effect is determined and used to update the current risk engagement.

There are naturally a vast number of modifications and alterations that could be made on the real-time risk determination system 701 without departing from the overall functionality and benefits achieved through the invention.

We claim:

1. Method for real-time deal engagement outcome determination for users of a deal engagement system, comprising the steps of in real time
receiving a first taken position from a user;
determining an outcome of each of a number of possible scenarios for said taken position;
storing said outcome of each of said possible number of scenarios;
determining a deal engagement outcome based on said stored outcome of the number of possible scenarios;
receiving at least one further taken position from said user;
for each received further taken position determine if said further taken position effects any of said outcomes of said number of possible scenarios;
if said further taken position effects any of said outcome of said number of possible scenarios then;
determine the net effect on said outcome;
modify said stored outcome of said number of possible scenarios by said net effect; and
modify said deal engagement outcome;
and
if said further position taken does not effect any of said outcomes for said number of possible scenarios then;
determine a further outcome of a further number of possible scenarios;
storing said further outcome of said further number of possible scenarios;
determine a further deal engagement outcome; and
modify said deal engagement outcome by adding said further deal engagement outcome.

2. Method according to claim 1, wherein determining said deal engagement outcome includes determining a risk engagement as a sum of a minimum of said stored outcomes of said number of possible scenarios and said stored further outcomes of said further possible scenarios.

3. Method according to claim 1, wherein determining said deal engagement outcome includes determining a gain engagement as a sum of a maximum of said stored outcomes of said number of possible scenarios and said stored further outcomes of said further possible scenarios.

4. Method according to claim 1, wherein determining said deal engagement outcome includes determining a balanced engagement as a sum of a weighing of all said stored outcomes of said number of possible scenarios and said stored further outcomes of said further possible scenarios.

5. Method according to claim 1, wherein only negative scenarios are considered for taken positions that can be withdrawn.

6. Method according to claim 1, wherein possible outcomes for the taken position are organized in the form of a structure comprising a number of discrete cases.

7. Method according to claim 6, wherein the discrete cases are represented by nodes and wherein a function determines the outcome for each node.

8. Method according to claim 7, wherein each node is associated with a value.

9. Method according to claim 8, wherein said value is related to a statistical distribution of likelihood for the outcome to occur.

10. Method according to claim 1, wherein the deal engagement outcome is automatically updated in real time for taken position where said number of possible scenario outcome is dependent on a time variable factor.

11. Method according to claim 2, wherein a current risk engagement is output to said user.

12. Method according to claim 11, wherein the current risk engagement is output each time the current risk engagement is modified.

13. Method according to claim 11, wherein the current risk engagement is output at specific intervals.

14. Method for real-time deal engagement outcome determination, comprising the steps of in real time registering at least one taken position;
determine a current deal engagement outcome for said at least one taken position;
for each further registered taken position determine a net effect of said each further taken position on said current deal engagement outcome; and
modify said current deal engagement outcome by said net effect.

15. Method according to claim 14, wherein said current deal engagement outcome is determined by analysing possible outcomes for said taken position, organized in the form of a structure comprising a number of discrete nodes.

16. Deal engagement system, comprising an input for receiving information regarding a number of taken positions with respect to an event initiated by a user, where a taken position can include one or more of a quote, a request, an order, a bid and an offer, a matching engine associated with the input for matching positions taken with respect to each event, an order book associated with the matching unit for storing un-matched positions and a deal engagement outcome determination unit associated with the matching engine and the order book for determining a deal engagement outcome for each user, whereby the deal engagement outcome determination unit is designed to determine a deal engagement outcome for each user based on the number of taken positions, which deal engagement outcome determination represents a combined outcome result for all possible scenarios that the number of taken positions can result in.

17. System for real-time deal engagement matching comprising,
means for entering a number of taken positions in relation to a number of deal objects,
means for determining possible scenario outcomes for entered taken positions having a common denominator, and
means for determining a deal engagement outcome as a combined outcome of said possible scenarios.

18. System according to claim 17 further comprising, means for matching entered taken positions, and means for storing un-matched taken positions.

19. System according to claim 17, wherein only negative scenarios are considered for un-matched taken positions.

20. Real-time deal engagement outcome determination system comprising;
an input for receiving a taken position;
a determination unit for determining a deal engagement outcome for said taken position in real-time;
a memory for storing said deal engagement outcome; and
an output for outputting said deal engagement outcome.

21. Real-time deal engagement outcome determination system according to claim 20, wherein said determination unit comprises a selection unit for selecting one of a plurality of deal engagement outcome determination structures based on said received taken position and a calculation unit for calculating said deal engagement outcome based on said selected deal engagement outcome determination structure.

22. Real-time deal engagement outcome determination system according to claim 21, wherein each of said plurality of deal engagement outcome determination structures includes a discrete number of nodes representing possible outcomes associated with a function for calculating said deal engagement outcome.

23. Real-time deal engagement outcome determination system according to claim 22, wherein each node is attributed a value.

24. Real-time deal engagement outcome determination system according to claim 23, wherein said value represents a statistical distribution of likelihood.

25. Real-time deal engagement outcome determination system according to claim 20, wherein said determination unit determines a net effect of each entered taken position on a stored deal engagement outcome and modifies said stored deal engagement outcome by said net effect.
